(19) United States
(12) Patent Application Publication
(10) Pub. No.: US 2017/0318056 A1
(43) Pub. Date: Nov. 2, 2017

(54) METHOD AND DEVICE FOR MONITORING THE SUPPLY OF AUTHENTICATION CERTIFICATES TO SERVICE NODES OF A HIGH-PERFORMANCE COMPUTER

(71) Applicant: BULL SAS, Les Clayes sous Bois (FR)

(72) Inventors: Julien GEORGES, Arpajon (FR); Thierry ICETA, Grenoble (FR); Emmanuel FLACARD, Ornacieux (FR)

(21) Appl. No.: 15/509,913

(22) PCT Filed: Sep. 2, 2015
(86) PCT No.: PCT/FR2015/052321

§ 371 Date: Jul. 3, 2017

(30) Foreign Application Priority Data
Sep. 9, 2014 (FR) 1458437

(51) Int. Cl. H04L 29/06; H04L 29/12; H04L 12/24; G06F 9/44

(52) U.S. Cl. CPC H04L 63/20; H04L 63/0823; G06F 9/4416; H04L 41/08; H04L 61/2015

(57) ABSTRACT

A method for monitoring the supply of authentication certificates to service nodes of a high-performance computer, includes a first step of defining for each service node an assembly of at least one authentication certificate, and then integrating each assembly defined for a service node into a configuration file associated with an identifier of the service node; a second step in which each service node transmits to a predefined server a start-up request intended for recovering the identifier thereof and a control file containing the assembly included in the associated configuration file; and a third step in which each service node extracts from the recovered control file the assembly contained therein in order to store each authentication certificate contained therein in an associated location in a corresponding storage area.

The invention relates to so-called “high-performance” type computers (or supercomputers), and more specifically to the monitoring of the supply of authentication certificates to service nodes that such high-performance computers comprise.

As those skilled in the art know, the booting of a high-performance computer (or supercomputer) may be quite a long operation, and thus an optimisation of said booting steps has to be carried out in order that its owner can use it as quickly as possible in a secure manner.

One of these steps consists in configuring each of the service nodes with a configuration tool after an initialisation phase. This configuration step requires the authentication of each service node by at least one authentication certificate that has been installed beforehand in a specific location of a storage area of the service node considered. Different methods of installation of authentication certificates of a service node have been proposed. But these methods are generally all implemented once the service node is in operation, which adds an additional step during the booting of its supercomputer.

The aim of the invention is notably to improve the situation, and notably to enable the service nodes to be authenticated with their server just after the end of the initialisation phase.

It proposes notably to this end a method, intended to monitoring the supply of authentication certificates to service nodes of a high-performance computer, and comprising:
a first step (i) of defining for each service node an assembly of at least one authentication certificate, then integrating each assembly defined for a service node into a configuration file associated with an identifier of said service node,
a second step (ii) in which each service node transmits to a predefined server a start-up request intended to recover the identifier thereof and a control file containing the assembly comprised in the associated configuration file, and
a third step (iii) in which each service node extracts from the recovered control file the assembly contained therein in order to store each authentication certificate contained therein in an associated location in a corresponding storage area.

It is thus possible to take advantage of the start-up (or boot-up or network boot) phase required by a service node with its server to transmit immediately to said service node each authentication certificate that will make it possible to authenticate it with said server during its configuration phase. This advantageously makes it possible to save time during booting of the different service nodes.

The method according to the invention may comprise other characteristics, which may be taken separately or in combination, and notably:
in the first step (i), each assembly may be integrated in a configuration file of “pxelinux.cfg” type;
in the first step (i), each identifier of service node may be an IP address; >in the first step (i), it is possible to integrate in each configuration file a name corresponding to the IP address of the associated service node in a hexadecimal form;
the first step (i) may be carried out in the predefined server;
in the third step, each service node can extract from the recovered control file each authentication certificate in order to place it in an authentication certificate(s) file.

The invention also proposes a computer programme product comprising a set of instructions which, when it is executed by processing means, is suitable for implementing a monitoring method of the type of that described above for monitoring the supply of authentication certificates to service nodes of a high performance computer.

The invention also proposes a monitoring device, intended to equip a high-performance computer comprising a server coupled to service nodes, and comprising:

first monitoring means arranged to define for each service node an assembly of at least one authentication certificate, then to integrate each assembly defined for a service node into a configuration file associated with an identifier of said service node and, in the event of reception of a start-up request emitted by a service node, to generate a control file containing the assembly comprised in the configuration file associated with the identifier of said service node, and triggering the transmission of said control file to the latter, and

second monitoring means implanted in each of the service nodes and each arranged to extract from a transmitted control file the assembly contained therein in order to store each authentication certificate of said extracted assembly in an associated location in a corresponding storage area of the service node concerned.

The invention also proposes a high-performance computer comprising a server coupled to service nodes, and a monitoring device of the type of that described above. For example, the server may comprise the first monitoring means.

Other characteristics and advantages of the invention will become clear on examining the description detailed hereafter, and the appended drawings, in which:

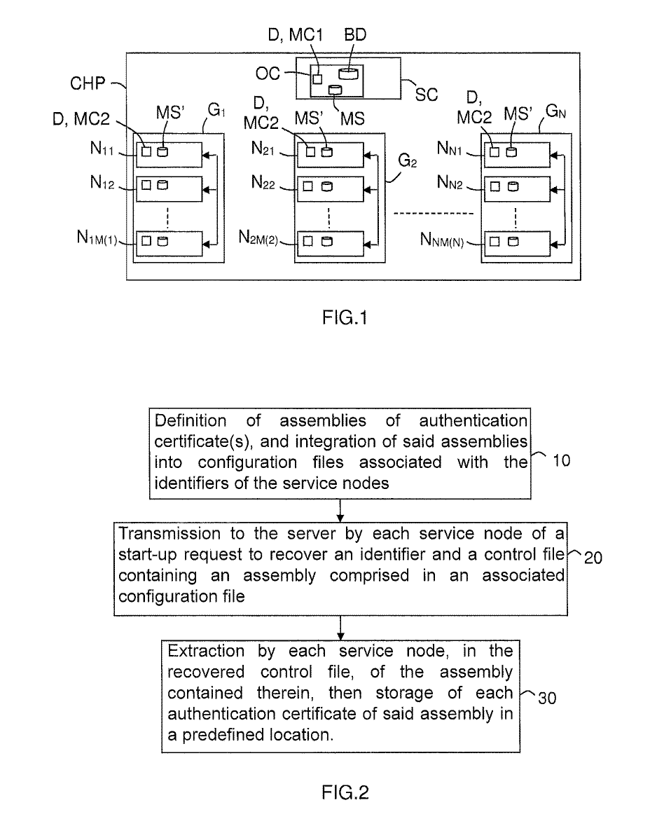

FIG. 1 illustrates, in a schematic and functional manner, a high-performance computer equipped with an exemplary embodiment of a monitoring device according to the invention, and

FIG. 2 illustrates an example of algorithm implementing a monitoring method according to the invention.

The aim of the invention is notably to propose a monitoring method, and an associated monitoring device D, intended to enable the monitoring of the supply of authentication certificates to service nodes Nᵢⱼ of a high-performance computer CHP.

In FIG. 1 is schematically illustrated a non-limiting example of high-performance computer CHP comprising a server SC coupled to service nodes Nᵢⱼ, for example via a communication network (such as for example the Internet). In this example, the service nodes Nᵢⱼ of the computer CHP are grouped together into N groups (designated high availability (or HA)) Gᵢ (with i=1 at N). Each (high availability) group Gᵢ comprises M(i) (service) nodes Nᵢⱼ (with j=1 at M(i)). For example, N is equal to 10 and M(i) is equal to 500 whatever the group Gᵢ considered (and thus whatever the value of the index i). But the number of nodes Nᵢⱼ could vary from one group ᵢ to the next G_{i′}. Furthermore, the number N of groups Gᵢ may take any value greater than or equal to one (1). Similarly, the number M(i) of nodes Nᵢⱼ of a group Gᵢ may take any value greater than or equal to three (3).

Each node Nᵢⱼ has available resources that are generally shared with the other nodes Nᵢⱼ (j′≠j) of its group Gᵢ, under the monitoring of a HA (high availability) software. These resources may be of any type from the moment that they are configurable services that are useful to the computer CHP or to an application running in this computer CHP.

The server SC assures several services linked to the network start-up (or boot) of the nodes Nᵢⱼ. Thus, it assures a DHCP (Dynamic Host Configuration Protocol) service intended to supply to the nodes Nᵢⱼ their IP addresses at the moment of the network boot. It may also assure “tftp” and “boot pxe” services for the transfer of hexadecimal files with the variables necessary for the authentication of the nodes Nᵢⱼ after the phase of initialisation and transfer of the image of the operating system having to be used by the nodes Nᵢⱼ. It may also, as illustrated in a non-limiting manner in FIG. 1, comprises a configuration tool OC intended to configure the resources of nodes Nᵢⱼ. It will be considered hereafter, as non-limiting example, that the configuration tool OC is Kconf® (sold by the BULL SAS company).

As indicated above, the invention proposes a method intended to enable the monitoring of the supply of authentication certificates to service nodes Nᵢⱼ of a high-performance computer CHP.

Said method comprises first (i), second (ii) and third (iii) steps, which may be implemented at least partially by a monitoring device D according to the invention.

As illustrated, a monitoring device D, according to the invention, comprises at least first MC1 and second MC2 monitoring means. The second monitoring means MC2 are installed in each of the service nodes Nᵢⱼ. In the non-limiting example illustrated in FIG. 1, the first monitoring means MC1 are installed in the server SC, and more precisely in the configuration tool OC. But this is not obligatory. They could in fact be an equipment that is external to the server SC but accessible by the latter (SC), for example via a computer connection, or instead that forms part of the server SC but not its configuration tool OC. Consequently, the monitoring device D may be realised either in the form of software modules (or computer modules, or “software”); in this case it is a computer programme product comprising a set of instructions which, when it is executed by processing means of electronic circuit type (or “hardware”), is suitable for implementing the monitoring method, or in the form of a combination of software modules and electronic circuits.

During the first step (i) of the method according to the invention, for each (service) node Nᵢⱼ an assembly of at least one authentication certificate is defined, then each assembly defined for a node is integrated into a configuration file associated with an identifier of the node Nᵢⱼ. This first step (i) is carried out by the first monitoring means MC1, potentially under the monitoring of a person authorised by the administrator of the computer CHP. It may be triggered in an automated manner within the scope of a process of contacting nodes Nᵢⱼ for the network boot, or instead manually at the initiative of the administrator of the supercomputer CHP.

This first step (i) is referenced 10 in the example of algorithm of FIG. 2.

Each assembly may comprise one, two, three or four authentication certificates, or even more if it so proves necessary.

For example, the first monitoring means MC1 may be arranged so as to generate each authentication certificate intended for a node Nᵢⱼ from information items that are stored in a database BD of the server SC and which define all the characteristics of the nodes Nᵢⱼ. This generation may take place by means of a first script. The authentication certificates thus generated may be stored in the server SC in the form of primary files in a predefined directory structure. In an alternative embodiment, the authentication certificates of the nodes Nᵢⱼ are already generated and the first monitoring means MC1 merely recovers them to store them in the server SC in the form of primary files in a predefined directory structure.

Then, the first monitoring means MC1 may be arranged so as to recover the contents of each primary file associated with a node Nᵢⱼ in order to format it and integrate it into one or more variable(s) of a configuration file associated with an identifier of the node Nᵢⱼ, pre-existing and for example stored in first storage means MS of the server SC, such as for example a memory. It will be understood that each variable corresponds to an authentication certificate.

Each identifier of node Nᵢⱼ is for example an IP address that is stored in the database BD among all the information items defining said node Nᵢⱼ.

As an example, each configuration file may be of “pxelinux.cfg” type. For example, for a given node Nᵢⱼ), the associated configuration file may be “/tftpboot/pxelinux.cfg/0A00000D”, where 0A00000D is the name of the configuration file in hexadecimal form, which corresponds to the IP address of said node Nᵢⱼ in hexadecimal format. This IP address of the node is defined by the DHCP service. The content of a configuration file is the standard text containing the boot instructions of the node Nᵢⱼ via the network. The integration of the values of authentication certificate variables may be done by means of a second script of the first monitoring means MC1.

During the second step (ii) of the method according to the invention, each node Nᵢⱼ transmits to the predefined server SC a start-up request that is intended to recover the identifier thereof (here the IP address thereof) and a control file that contains the assembly of authentication certificates comprised in the associated configuration file (that is to say containing the IP address thereof).

This second step (ii) is referenced 20 in the example of algorithm of FIG. 2.

For example, when the administrator of the supercomputer CHP wishes to start up the nodes Nᵢⱼ it triggers the sending of start-up requests by these nodes Nᵢⱼ. To this end, it orders the nodes Nᵢⱼ to start up (or boot) via the network. The continuation takes place automatically for each node Nᵢⱼ by the sending to the server SC of a start-up request preferably of “PXE network boot” type. This triggers a contact with the server SC thanks to the IP address of the node Nᵢⱼ obtained via the DHCP service, then the recovery by said node Nᵢⱼ of its hexadecimal configuration file on the pxe service of the server SC, and obtaining by this node Nᵢⱼ the operating system SC thereof via the transfer service tftp of the server SC.

On reception of a start-up request transmitted by a node Nᵢⱼ, the first monitoring means MC1 are going to determine in the storage means MS the configuration file that contains the IP address of said node Nᵢⱼ). Then, they are going to extract from said configuration file the value of each authentication certificate variable in order to integrate it into a control file, and finally they are going to order the server SC to transmit said control file to the requesting node Nᵢⱼ. For example, this control file may be of “/proc/cmdline” type.

During the third step (iii) of the method according to the invention, each node Nᵢⱼ extracts from the control file that it has recovered (consecutively to the sending of its start-up request) the assembly of authentication certificate(s) contained therein in order to store each authentication certificate contained therein in an associated location in a corresponding storage area MS′. This storage area MS′ is for example a memory of a node Nᵢⱼ that is used to store indispensable data throughout the phase of running said node Nᵢⱼ.

This third step (iii) is referenced 30 in the example of algorithm of FIG. 2.

It is the second monitoring means MC2 of each node Nᵢⱼ that perform the extraction of the value of each authentication certificate variable, then which convert each extracted value into a format comprehensible by its node Nᵢⱼ, and finally that place each converted value in the associated location of the storage area MS′. This location comprises for example a predefined directory structure and at least one predefined file. This extraction, this conversion and this placement (or storage) may take place by means of a script.

For example, in the third step (iii), before the second means of monitoring MC2 a node Nᵢⱼ carry out the storage (or placement), they can extract from the recovered control file each authentication certificate in order to place it (after its potential conversion to the correct format) in an authentication certificate(s) file. It will be noted that when the node Nᵢⱼ already comprises an original authentication certificate(s) file when it receives a control file, its second monitoring means MC2 may either store the original file in another predefined storage area and the new authentication certificate(s) file at the location where the original file was stored (namely in the storage means MS′), or simply replace (or overwrite) the original file by the new authentication certificate(s) file in the storage means MS′. In the absence of difference, the original file is conserved, as is, at the location where it is stored (namely in the storage means MS′).

Thanks to the invention, it is henceforth possible to take advantage of the start-up (or boot-up or network boot) phase that is required by a service node with its server to transmit immediately to this service node each authentication certificate that will then make it possible to authenticate it with said server during its configuration phase. The result is a notable reduction in the time of booting each service node of a supercomputer.

The invention is not limited to the embodiments of monitoring method, monitoring device, and high-performance computer described above only as examples, but it encompasses all the alternative embodiments that those skilled in the art could envisage within the sole scope of the claims hereafter.

1. A method for monitoring the a supply of authentication certificates to service nodes of a high-performance computer, the method comprising a step (i) of defining for each service node an assembly of at least one authentication certificate, then integrating each assembly defined for a service node into a configuration file associated with an identifier of said service node, a step (ii) in which each service node transmits to a predefined server a start-up request intended for recovering the identifier thereof and a control file containing said assembly comprised in said associated configuration file, and a step (iii) in which each service node extracts from said recovered control file the assembly contained therein in order to store each authentication certificate contained therein in an associated location in a corresponding storage area.

2. The method according to claim 1, wherein in step (i) each assembly is integrated into a configuration file of pxelinux.cfg type.

3. The method according to claim 1, wherein in step (i) each identifier of service node is an IP address.

4. The method according to claim 3, wherein in step (i) a name corresponding to said IP address of the associated service node is integrated into each configuration file in a hexadecimal form.

5. The method according to claim 1, wherein step (i) is carried out in said server.

6. The method according to claim 1, wherein in step (iii) each service node extracts from said recovered control file each authentication certificate in order to place it in an authentication certificate(s) file.

7. A non-transitory computer program product comprising a set of instructions which, when executed by a processor, implement the method according to claim 1 for monitoring the supply of authentication certificates to service nodes of a high-performance computer.

8. A monitoring device for a high-performance computer comprising a server coupled to service nodes, characterised in that it the monitoring device comprising i) first monitoring means arranged to define for each service node an assembly of at least one authentication certificate, then to integrate each assembly defined for a service node into a configuration file associated with an identifier of said service node, and, in the event of reception of a start-up request emitted by a service node, to generate a control file containing the assembly comprised in the configuration file associated with the identifier of said service node, and to trigger the transmission of said control file to the latter, and ii) second monitoring means implanted in each of said service nodes and each arranged to extract from a transmitted control file the assembly contained therein in order to store each authentication certificate of this the extracted assembly in an associated location in a corresponding storage area of the service node concerned.

9. A high-performance computer comprising a server coupled to service nodes, and a monitoring device according to claim 8.

10. The high-performance computer according to claim 9, wherein said server comprises said first monitoring means.
